(19) United States
(12) Patent Application Publication
(10) Pub. No.: US 2011/0091616 A1
(43) Pub. Date: Apr. 21, 2011

(54) METHODS FOR OBTAINING PRESERVATIVE-FREE STABLE AVOCADO PULP POWDERS AND PRODUCTS COMPACTED FROM SAME

(75) Inventor: Dimas Jimenez Mendoza, Mexico (MX)

(73) Assignee: QUINASA S.A. DE C.V., Mexico, DE (MX)

(21) Appl. No.: 12/919,475

(22) PCT Filed: Feb. 28, 2008
(86) PCT No.: PCT/MX2008/000034

§ 371 Date: Dec. 6, 2010

(30) Foreign Application Priority Data
Feb. 26, 2008 (MX) MX/A/2008/002698

(51) Int. Cl. A23L 1/212; A23B 7/02; A23L 2/38; A23B 7/01; A23G 9/42; A23G 3/48; A23L 3/01

(52) U.S. Cl. 426/242; 426/640; 426/590; 426/572; 426/565; 99/451

(57) ABSTRACT

Example embodiments relate to methods for obtaining stable avocado pulp powders having a long life shelf life at ambient temperature, without requiring the use of natural or synthetic preservatives. The example methods thereby enable the natural components of the pulp and the organoleptic properties of the fruit to be preserved. The powders can be used to obtain compacted products, such as tablets for food or cosmetic use. The example embodiments further provide dehydration methods for obtaining avocado pulp powders, in which the avocado pulp is dehydrated using microwaves and hot air flows simultaneously. Thus, powders with low water activities may be produced without adding preservatives, while eliminating unwanted enzyme activities specific to the fruit.

This application claims priority to Mexican Patent Application MX/a/2008/002698 of Feb. 26, 2008 hereby incorporated by reference.

### BACKGROUND OF THE INVENTION

1. Field of the Invention

This application relates to methods for the preservation of shelf short life fruits by means of its dehydration, particularly to the avocado pulp preservation by means of its transformation into a stable powder having a shelf long life through the dehydration of the pulp using microwaves combined with a hot air flow; as well as with the products that contain such powders.

2. Description of the Related Art

The avocado is one of the world-wide more appreciated fruits, due to the multiple benefits that its consumption provides, as much in the alimentary and cosmetic industry. Unfortunately, the reduced shelf life of the complete fruit or the pulp, are factors that significantly limit their consumption in places where the fruit is not harvested. Thus, one of the greater problems is the fast degradation of the components of the pulp of the fruit due to chemical and enzymatic events of the pulp, which are quickly activated when the pulp is exposed to the environment. These phenomena known as enzymatic or non-enzymatic darkening, are the main cause of the fast degradation of the avocado pulp as well as of the pulp of other fruits of great consumption, even in those alimentary compositions based on avocado. Due to these phenomena, the avocado preferably is consumed fresh and in short times, which can only be feasible in zones where its harvest takes place.

In order to solve this problem, diverse methodologies directed to the preservation of the avocado pulp or of the complete fruit by means of heat or dehydration have been reported. Since it has been seen in other fruits, these techniques get to be very effective to preserve original the sensorial and alimentary properties of the avocado fruit. In this way, the addition of hot wet air to the whole avocado fruit has been reported (Ornelas, J. of Jesus, et. at. 2004. Effects of Prestorage Dry and Humid Hot Air Treatments on the Quality, Triglycerides and Tocopherol contents in Hass Avocado Fruit. Journal of Food Quality 27: 115-126), as well as the heating of the avocado pulp technique in an environment of pH higher than 8, managing to increase to the shelf life of these products (International Patent Application WO/2004/100670, Griebel, Jonathan M., et. al. 2004. Method of treating avocados and method of preparing guacamole there from).

Also the preservation of the avocado pulp by means of osmosis in the presence of dehydrating agents has been obtained (WO/2003/067996, Koyazounda, Antoine. 2003. Method for stabilizing fruit pulp or vegetable flash, particularly avocado pulp).

International Patent application WO/2006/088344 (Diaz Garcia, Ernesto, Et al. 2006. Process for obtaining avocado powder) discloses a method to dehydrate avocado, with the purpose of preventing the oxidation of fats and the decomposition of the compounds that confer their color, scent and flavor to him. The powder is obtained by means of a method consisting of: to select the avocado, to separate the seed and rind, to grind to obtain a paste, to place the ground avocado in containers for dehydration, to cool quickly with liquid nitrogen to inhibit the enzymatic activity and, to dehydrate by freeze-drying (lyophilization) and finally, to pulverize the obtained product.

In addition, it has been reach the preservation of the avocado pulp through a dehydrated paste obtained by means of spray drying as side products of the continuous processes of the oil extraction of avocado pulp having diverse uses (WO/2007/105969, Phillips, Martin Lewis. 2007. Powdered compositions and processes preparing them.)

The Mexican patent application No PA/a/2003/010392, (Jimenez-Mendoza, Dimas. 2004. “Stabilized Avocado Pulp Flour, alimentary process for obtaining it and products therefrom”), describes a process by means of which a stable pulp flour is obtained by means of conventional methods of dehydrating avocado, which in addition, it is added with natural and chemical conservatives. The process includes the steps of selecting and washing the avocados, cutting and eliminating the seed, dehydrating the pulp by means of any conventional process (preferably by anyone of the methods of heat drying, microwaves or interchange), separating the rind and milling of the dehydrated pulp and finally adding and mixing conservatives.

Although the previous methodologies have increased considerably the shelf time life of the avocado pulp, most of them include additives, which affects the original sensorial properties of the fruit and it does not allow to obtain pure dehydrated avocado pulp without such substances. Also, the times and stages of treatment of the pulp, get to be extended and cannot be enabled at industrial level, Which result in high consumption of energy and economic resources.

For the preservation of the avocado pulp by means of dehydration in shorter times, most of the methodologies reported until know include the treatment of the pulp by means of microwaves, in other foods such methodology has demonstrated to be effective and advisable to obtain acceptable yields of the material treated in less time and prevents that the original components are significantly altered. The above in comparison with the extraction treatment suitable for dehydrating fruits (Sharma, Upendra K., et. a. 2008. Microwave-assisted efficient extraction of different part of Hippophae rhamnoides for the comparative evaluation of antioxidant activity and quantification of its phenolic constituents by reverse-phase high-performance liquid chromatography (RP-HPLC). J. Sour. Food Chem, 56: 374-379), or if compared with the process for obtaining avocado oil (Ortiz Moreno, Alicia, et. al. 2003. Effect of different extraction methods on fatty acids, volatile compounds, and physical and chemical properties of avocado (Persea American Mill.) oil. J. Sour. Food Chem. 51: 2216-2221).

In the case of the dehydration of the avocado pulp by means of microwaves, stable products have been obtained by means of the addition of cucurbitacea extracts to the avocado pulp, previous to the step of drying (Haendler, Lucien, et. a. 1977. Method of Preparing Avocado-Pear Pulp Powder Containing Cucurbita Moscato as a Stabilizer and Product.), or the stable residual dehydrated paste obtained as a by-product of the avocado oil obtaining process, which is extracted from the pulp of the fruit before the dehydration step (WO/2006/004388. Dorantes Alvarez, Lydia, ET. to. 2006. Method for obtaining the extra virgin oil of the avocado pulp and a residual low calorific content paste which reduces the environmental contamination).

Application WO/2006/004388 describes a method for obtaining the virgin extra oil of the avocado pulp with high content of vitamin, fitoesterols, luteine and chlorophylls, without the use of dissolvents and/or chemical reagents. The method comprising (a) to subject the avocado pulp to a microwave heating, followed by (b) to squeeze the pulp, (c) to store the pulp under refrigeration and (d) to centrifuge. In said publication, it is mentioned that by virtue of his low humidity content, the residual paste obtained does not require refrigeration, it is stable to the heat and it can be used for preparing sauces, dressings, creams, etc.

Rendek (U.S. Pat. No. 3,520,701 Rendek, Robert B. 1970. Method of making a foamed meta flake), describes a method to obtain dehydrated meat flakes by means of the use of microwaves, consisting in impregnating chopped or ground meat with water, salt and condiments, then dehydrate the meat using microwaves to a temperature from 63.8 to 62.7° C. (145 to 147° F.). It is also described that hot air circulates to the interior of the microwave oven. The method yields a product having from 2 to 6% of humidity content, which in turn is used to obtain flakes. Nevertheless, the above mentioned method does not produce dehydrated avocado pulp powder, stable at room temperature and without the addition of improper substances or conservatives. The method described by Rendek for dehydrating avocado pulp, render a powder that in short time presents enzymatic darkening, which in turn result in the lost of the sensorial properties of the avocado pulp.

Noboru (JP2004305002 Noboru, Sugihara, et. a. 2004. Method Producing Dried Fruit and Vegetable Food and Apparatus for Production) describes a continuous method for dehydrating fruits and vegetables by microwaves using an apparatus equipped with at least 5 drying chambers, arranged in series, which apply microwaves to the eatable material, as well as of means that provide hot air to the interior of the drying chamber which are able to regulate the temperature and the hot air flow. The material placed in trays moves to the interior of each one of the chambers by means of transport means, obtaining thus dehydrated material. Nevertheless, the method described by Noboru does not allow to obtain pulp powders of avocado without enzymatic darkening, due to the fact that the general conditions of dehydration described are not enough sufficient to remove the enzymatic activity responsible of the enzymatic darkening of the avocado pulp.

Yuanzhi (CN1528165. Yuanzhi, Li, et. al. 2004. Method for Applying Microwave Technology in Preserved Fruit Processing) describes a method for the preservation of fruits by means drying by microwaves or drying by means of hot air, wherein the fruits are previously saturated with sugar. However, the described method adds sugar to the fruit, which in turn affects the sensorial properties of the fruits. Likewise, it does not allow the obtension of the stable avocado pulp powder free of enzymatic darkening due to the high content of water that the obtained products (10 to 20%).

Boutang (EP-0431703. Boutang, Jerome Jean M., et. al. 1991. Treatment of fruits), describes a method for the treatment of fruits and further integration to alimentary compositions. The fruits are dried by means of a flow of air hot at no more than 40° C. which can be optionally heated obtained using microwaves, further immersion in sweetened solutions and freezed until its use. However, the method does not remove the enzymatic activity responsible of the enzymatic darkening in the avocado pulp and it does not remove the humidity of the food at suitable levels such that allow the obtension of the avocado pulp powder.

The article Jimenez, M. E., Et. Al., (“Stability of Pigments in Fruits Subject to a Treatment with Energy of Microwaves” Inf. Tecnol. [online], 2004, vol. 15. No 3, of the named inventor of the present patent application, describes the effect of the treatment by microwaves in avocado milled or ground on the chlorophyll degradation and the polyphenoloxidase activity. This publication either does not describe the stable avocado pulp powder free of enzymatic darkening according to the invention.

This way, the methods of the prior art do not yield the avocado pulp powder free of conservatives which provide stability in shelf, or stable powders that contain the original components in the avocado non-treated pulp.

As it can be noted, the exists a necessity of a method to dehydrate, in short time, the avocado pulp by means of microwaves, without the use of conservatives and simultaneously, able to inactivate the enzymatic activity of the pulp of the fruit, the above with the purpose of obtaining pulp powders of avocado having prolonged shelf life and that exhibits the original sensorial properties of the fruit.

### SUMMARY OF THE INVENTION

It is one of the objectives of the invention to provide pulp powders of avocado with a prolonged shelf life without the use of conservatives.

Another objective of the invention is to provide alimentary compositions that contain stable avocado pulp powders of prolonged shelf life without the use of conservatives.

Another objective of the invention is to provide compacted products that contain stable avocado pulp powders of prolonged shelf life without the use of conservatives.

A further objective of the invention is to provide a method for obtaining the stable avocado pulp powder without the addition of conservatives. The objectives of the invention are reached by providing a method including dehydration of the avocado pulp by microwaves and the simultaneous hot air administration during the drying.

### BRIEF DESCRIPTION OF THE DRAWINGS

The present invention will become more fully understood from the detailed description given herein below and the accompanying drawings which are given by way of illustration only, and thus, are not limits of the present invention, and wherein:

FIG. 1 shows a diagram of the dehydration system of the invention. One can distinguish the microwave oven (1), air inlet (2) and air exit (3), rotatory tray (4), air valve (5), heating mean (6), and humidity controller (7). The air flow is indicated by arrows.

FIG. 2 shows an arrangement of a plurality of dehydrating apparatus of FIG. 1 for the treatment of diverse batches. One can distinguish the microwave ovens (1), air inlet (2) and air exit (3), rotatory tray (4), air valve (5), heating mean (6), and humidity controller (7). The air flow is indicated by arrows.

FIG. 3 shows a comparative chart of the percentage of reflectance (% R) of some powder of avocado samples of the invention taken from the batch 11 (A), 17 (B) and 24 (C) listed in table 1, being compared with fresh avocado pulp as standard.

### DETAILED DESCRIPTION OF A PREFERRED EMBODIMENT

The present invention describes pulp powders of avocado with extended shelf life at room temperature without the use of conservatives and maintaining the original components of the pulp when the fruit is fresh. Said feature allow overcoming the problems associated with the transport and conservation of the fresh fruit, whereas at the same time the sensorial and nutritional properties of the pulp of the fruit are preserved.

The powders of the invention have very low humidity content, from 2 to 7% w/w at the most, as well as values of water activity from 0.25 to 0.59. These features allow to prevent their contamination with microorganisms and contributes to avoid enzymatic and chemical events of the pulp that take place when the pulp is exposed to the air and which are responsible of enzymatic or non-enzymatic darkening. In addition, in the powders of the invention it is not possible to detect activity of polyphenoloxidase that allows to guarantee its stability in shelf and to preserve the original components of the pulp.

Until before the present invention, it had not been possible to obtain the properties described for the powder of the invention without the previous or later addition of conservatives to the pulp during its dehydration by microwaves. Due to the above, the present invention solves the previous impossibility to obtain stable pulp powders of avocado without the use of conservatives by means of its dehydration by microwaves, thus providing products of high quality and efficient methods for obtaining them.

Moreover, the method of dehydration of the invention allows to obtain pulp powders of avocado with almost the same concentration of its original components, as well as particle size suitable for its consumption, great rehydrating properties and a long shelf life. The stability which powders of the invention exhibit gets to be minimum from 1 year at room temperature, which is comparable with flours of avocado reported previously in Mexican patent application MX/a/2003/010392 of the same inventor of the present invention, but without the disadvantage of including conservatives in order to obtain its long life in shelf. Also, the percentage of humidity and water activity of the powder of the invention, allow obtaining powders with suitable sizes of particle for their consumption, without problems for rehydrating itself and with adequate conditions for their later compaction, which in turn increases its shelf life and availability.

The powders of the invention have very suitable sizes of particle for their consumption and later compaction, which enable later diverse manipulations of the powder thus obtained, having the possibility of generating powders with diverse useful sizes of particle for multiple applications. In this sense, the size of particle of the powder is of 0.5 to 2.5 mm, although the preferred size of particle is from 1.0 to 2.0 mm.

The compositions that can be formed from the powders of the invention, depends on the desired use. It can fid application in the alimentary or cosmetic industry. Unlike powders of avocado with conservatives of the prior art, the powders of the invention can be used in cosmetic compositions because they do not contain conservatives and exhibit absence of microbial growth. Due to this fact, the powder can be used in a safety form.

For preparing alimentary compositions, the powders of the invention can be mixed with liquid or solid substances such as potable water, milk, juice, concentrated, pastes, products of confectionery, etc., that can be consumed in direct form, by which it can be used to obtain diverse kinds of drinkable compositions, such as refreshing drinks, shales or smoothies, syrups or the like, depending on the eatable substance that are used; or alimentary blends as desserts, pastes, guacamole, etc. This process can be made directly by the consumer or in the industry of drink obtaining for example, simply dissolving a small amount of the concentrated powder of the invention directly in a glass with water or milk and optionally adding a desired quantity of sugar or sweetener. As in the case of drinks, the powder of avocado of the invention can be blended perfectly with yogurts, ice creams, pies, jams, jellies, diverse products of confectionery, alimentary condiments, nutritional complements, foods for babies, mushes or spirituous liquors, resulting in excellent alimentary products with avocado flavor.

The powder of the invention can be used to provide flavor to avocado pulp in multiple alimentary blends, for that purpose a sufficient amount provide desired avocado flavor, aspect and aroma to the foods. For example, in said alimentary blends, the powder of avocado of the invention can be added in amounts from 20 to 40% in weight with respect to the total weight of the alimentary blend. The powder of the invention is able to develop the desirable intensity of avocado flavor and scent in the food where they are added, as consequence it can be added low amounts of it, although the final amount depends on the preference of the consumer.

The powders of avocado of the invention are obtained by means of dehydration of the pulp, using a method that includes the combination of dehydration by microwaves and the simultaneous addition of a constant flow of hot air on the pulp. This process allows to eliminate the activity of polyphenoloxidase and other enzymes of the fruit that are responsible for the degradation of the components of the pulp, whereas at the same time significantly reduces the humidity of the pulp and the water activity of the fresh fruit. These effects prevent the development of microbial growth in avocado powders obtained and the preservation of the typical sensorial properties of the fruit, without adding natural or synthetic conservatives to the pulp of the fruit, or either after or during the dehydration.

The method described here has the capacity to process from 5 to 50 kg of avocado pulp, which can be increased by means of the implementation of diverse processing batches, depending on the amounts that are necessary to obtain from the powder.

The process of obtaining the powder of the invention includes the following stages:

a) Selecting and washing of the whole avocado fruit.

During this stage whole fresh fruits of avocado are classified by means of a conventional classifying transporter, choosing those fruits that are in suitable conditions, that is to say, those fruits that are not struck or with the fractured or scratched rind and exhibiting a firm consistency. Then, the selected fruits are washed and sanitized with chlorinated water (20 ppm) to eliminate undesirable residues adhered to the rind and to avoid contamination of the pulp when the rind is retired later. Next the whole fruits wrings and blowed with air to eliminate the washing water; the water resulting of this process is received by a tray and drained.

b) Cut and remotion of the avocado seed.

The whole fruits treated in the previous stage, are manipulated and cut longitudinally in halves to access and eliminate the seed of the fruit by means of the use of a blade.

Once the seed is eliminated, the non-eatable separated material of the fruit is removed and placed it in a transporting band for disposing it.

Although it is preferred at this stage not to eliminate the rind of the cut fruit before to put the fruit under dehydration, for effects of the invention, it is possible also to remove the rind of the fruit along with the seed to obtain the only pulp of the fruit.

c) First dehydration stage.

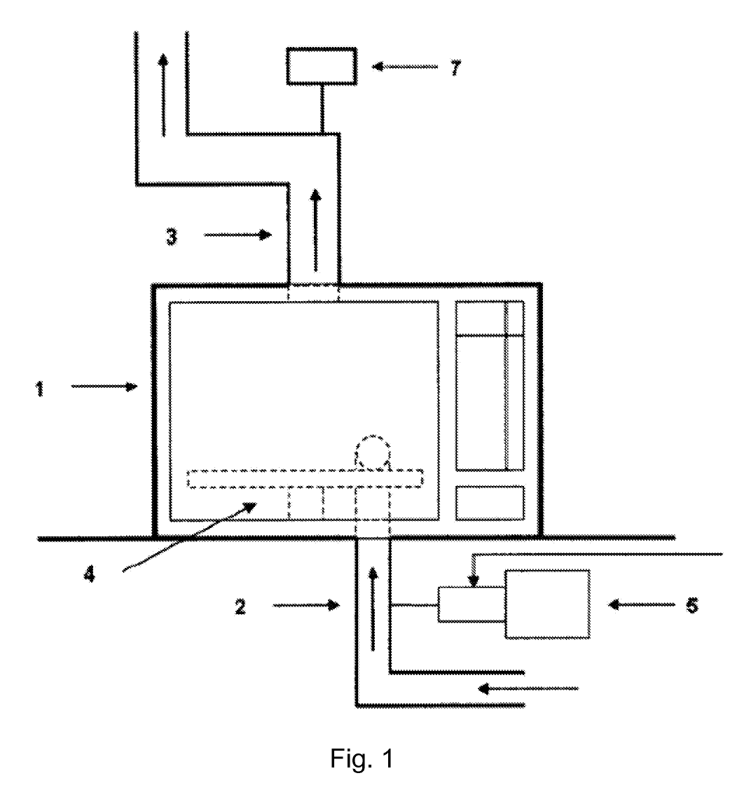

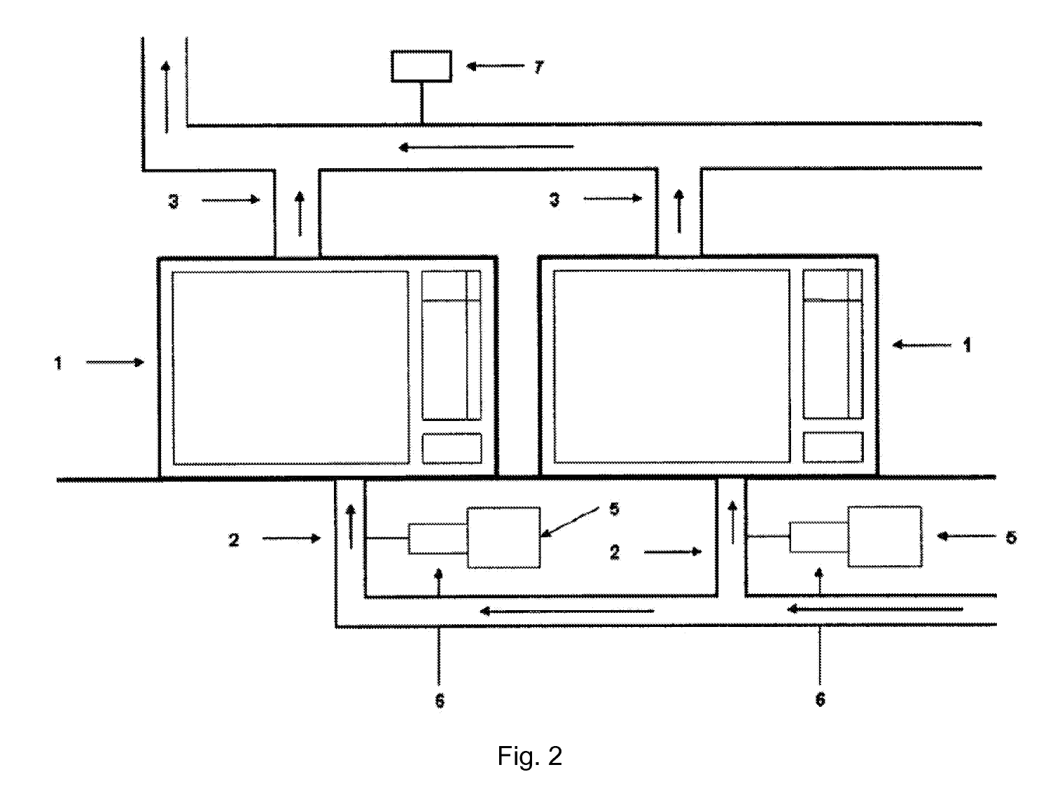

Once the seed is removed and the pulp of the avocado exposed, the cut fruit is placed inside an microwave oven (1) equipped with a rotatory tray (4) as well as with an inlet (2) and exit (3) of hot air, as it is depicted in FIG. 1. The air intake (2) is placed in the opposite sidewall to the door of the oven (1), over the inferior base of the oven (1) to a side of the rotatory tray (4), in such a way that when the air is injected to the interior of the oven (1), the exposed surface of the pulp of the fruit is touched by the air. The air exit (3) is placed in the superior cover of the oven (1). So that, when the air enters, the air swirl inside the oven touching the surface of the pulp of the fruit and finally leave the oven. Once the cut fruits are placed in the trays, they rotate at 2 to 8 turns per minute, it is provided from 10 to 80% of the power of the microwave oven, and simultaneously it is injected air having a temperature from 40 to 90° C. to the interior of the oven and a flow speed of 0.2 to 0.9 m3/min. The dehydration is conducted during 40 to 90 minutes until obtaining a material derived from the avocado pulp with humidity at a maximum content from the 8 to 12% w/w. In one of the embodiments of the invention, this stage of dehydration can also be conducted in batches, wherein the fruits are subjected to the conditions of dehydration, but arranging a plurality of microwave ovens with inlets and exits of air as depicted in FIG. 2.

This arrangement allows the dehydration of greater amounts of the fresh avocado pulp, obtaining bigger quantities of the powder of the invention and consuming the same time. In this regard, the dehydration system by batches can consist of, for example, 15 microwave ovens arranged in parallel (see FIG. 2), depending on the production goals for obtaining the powder of the invention.

d) Second dehydration stage.

Finished the first stage of dehydration, the pulp partially dehydrated is subject to a second stage of dehydration by means of any conventional method that yields the complete dehydration of the pulp. However, the method of dehydration is preferably selected from the group that includes heat drying or by means of hot air. The election of the method depends in great extent on the design of the plant of processing for the obtaining of the powder of the invention, but for effects of the invention anyone of the mentioned drying process provides favorable results. For the case of the use of heat drying the dehydration it is made in an interval of temperature of 55 to 120° C. in a time from 0.5 to 4 hours, whereas for the dehydration by hot air it is made to a temperature from 60 to 120° C. during 3 to 6 hours.

The avocado pulp is dehydrated until obtaining a material with a maximum content humidity from the 2 to 7% w/w and with a water activity from 0.2 to 0.59. During this stage of dehydration, samples of the dehydrated pulp are take to determine its water activity. If the value of water activity of the dehydrated product is not within the specified interval, the dehydration process of the pulp continues until obtaining a pulp with values of water activity within the mentioned range.

The material obtained at the end of this stage is dehydrated avocado with a very low humidity content and water activity, halves or chucks of the fruit holding the characteristic color of avocado pulp.

e) Milling of the dehydrated avocado.

Finished the process of dehydration of the fruit halves or chucks, this it is cooled to reach the room temperature and the dehydrated halves or chucks obtained are placed in a mill; in case that the pulp had been dehydrated along with the rind of the fruit, the pulp is optionally separated from the rind by means of a stainless steel spoon previously sanitized. The rind is disposed. The dehydrated pulp is ground by means of a conventional mill under such conditions to obtain a particle size from 0.5 to 2.5 mm; next the obtained milling is sifted by means of a grain classifier having a mesh of a suitable size that allows to sieve above mentioned particles, for example, of mesh 14 to 25. In this stage of the process, the particles that have been retained by the grain classifier are returned to the milling step with the purpose of obtaining the suitable size of particle.

The method of the invention allows to remove a great amount of humidity of the pulp, providing avocado pulp powders of great stability in shelf and which do no need conservatives, keeping the original and typical sensorial properties of the pulp of the fresh fruit. Also, the method of the invention prevents that the pulp becomes denatured during the dehydration steps, caused either by excessive heating or by appearance of enzymatic or non-enzymatic darkening. The conditions of the process of the invention allow to obtain avocado pulp powders that conserve their original sensorial properties, with low values of water activity and very low humidity, as well as a high stability in shelf with no need to add conservatives. Due to the method of the invention, in the avocado powder obtained it is not possible to detect activity of polyphenol oxidase, which result in great stability in shelf at room temperature, avoiding the necessity of refrigeration to conserve the product. Also, the low water activity and low humidity content of the powder described here, prevents the microbial growth. These features allow that the avocado pulp powder of the invention conserves its sensorial properties to room temperature during long periods of storage, enabling thus their use in any industry, either for direct alimentary consumption in alimentary compositions, or for cosmetic use.

In order to verifying the quality of the obtained product it is possible to obtain samples of the pulp at different stages of the method of the invention, as well as measures of humidity and water activity, which allows to guarantee the quality of the final product.

The powder of avocado obtained under the method of the invention, is packaged by well know techniques, for example, by means of continuously packaging in hoppers. In this way, the packages that are suitable for the storage of the powder of avocado pulp of the invention are those that can be manipulated easily and that offer resistance during his handling, for example polyethylene, polypropylene, aluminized or cellophane bags, which after sealed, can be introduced in PET (Polyethylene Terephtalate) bottles, glass bottles or cardboard boxes with inner plating. Although the stability of the powder of the invention does not depend on the type of package used, the mentioned packages allow a better handling for their shipping, transportation, storage and later use.

The method of the invention allows to obtain significant yields with respect to methods of the prior art, It is possible to obtain yields of 200 g of powder per 1,000 g of fresh fruit. This is possible because during the stages of dehydration according to the method of the invention the pulp is not manipulated. Such feature significantly reduces the shrinkages of the dehydrated product.

Respect to the milling stage of the dehydrated pulp, this can be made by means of any suitable milling apparatus, disintegrator or size reductor until obtaining the size of particle that is advisable for its consumption.

The method of the present invention highly reduces the humidity content of the fresh pulp of the fruit but without getting to eliminate it absolutely, by which the risk of carbonization of the raw material is prevented. Also, the powder of the invention can be rehydrated easily without formation of agglutinated balls, and obtaining pastes with a similar visual aspect to the one of the fresh pulp of the fruit, as well as with the original typical nutrients of the fresh fruit.

The method of dehydration of the invention by means of microwaves provides to the avocado pulp with the heat in a faster and efficient way, whereas the simultaneous hot air flow takes the generated humidity to the outside, improving with this the dehydration process since the drying time is reduced and the product maintains its original sensorial features. The method of dehydration described here reduces to the pulp drying time at least in 60% when compared with the dehydration using microwaves or drying with hot air.

For the purposes of the invention, the dehydration is conducted with the microwave apparatus shown in FIG. 1. As it can be noted, it consist of a microwave oven (1) equipped with a rotatory tray (4) as well as with an air inlet (2) and air exit (3). The air inlet (2) is placed in the sidewall opposite to the door, over the inferior base of the oven (1) next to the rotatory tray (4), in such a way that when the air is injected to the interior of the oven (1), the air become in contact with the exposed surface of the pulp of the fruit. The exit of air (3) is placed in the superior cover of the oven (1), So that when the air enters, the air can circulate in its interior touch the surface of the pulp, absorb the evaporated water of the fruit and finally leave the oven. In order to heat the air flow a resistance (6) from 100-300 watts is placed in the air inlet (2). Such resistance (6) warm up the air to the wished temperature. Likewise, the valve (5) regulates the air intake to the oven (1). The air inlet (2) and exit (3) are connected to corresponding ducts, preferably made of stainless steel, independently one of the other, that allows to prevent interferences of the air flow. In duct of exit (3) of air of the system, it is placed a humidity controller (7), to sense the humidity content in the air flow that leaves the oven (1), making the dehydration more controlled and efficient.

The apparatus of FIG. 1 can be placed in parallel or series with other identical apparatuses to allow the simultaneous dehydration of diverse batches of avocado pulp (see FIG. 2), such arrangement increases the productivity of the dehydration method of the invention. As it can be noted, the air is provided to each one of the ovens (1) of the system by means of independent air inlet ducts (2), which are connected to each other by means of a single manifold in their lower part, whereas the independent exit ducts (3) of each oven (1), are connected to each other through a single tube that allows to extract the air. This allows that the air flows in series to the interior of each one of the arranged ovens (1), allowing the dehydration of diverse batches of fresh avocado pulp to the same conditions and at the same time.

Several methodologies based on the dehydration with microwaves for the food preservation have been reported, nevertheless until the present invention, any of them has been effective for obtaining the avocado pulp powder with long shelf life and without the use of conservatives.

As it can be observed, in contrast to the methods of the prior art, the method of the present invention provides stable avocado pulp powders, being eliminated the necessity of adding natural or synthetic conservatives. The powder of the invention, maintain the original sensorial features of the fresh fruit during long periods of storage and without the addition of substances to the pulp.

The avocado pulp powder of the invention can be used to prepare derived products such as spicy hot products (, chocolate bars, alimentary products such as cream or sweet paste, sweet products such as hard caramels, or spicy hot sauces for example, guacamole) obtained by means of conventional methods of preparation and blend. As it is described in Mexican patent application MX/a/2003/010392 of the same inventor and incorporated by reference, with the powder of the invention it is possible to obtain a plurality of alimentary blends of high quality, but with the great advantage of using avocado pulp powder without conservatives, which allows not to alter the flavor of the food.

In one of the embodiments of the invention, a spicy hot alimentary product with the avocado pulp powder of the invention can be obtained mixing the powder in a percentage from the 90 to 95% in weight with respect to the total weight of the spicy alimentary product, and a mixture of chili in a percentage from the 5 to 10% in weight with respect to the total weight of the spicy alimentary product. The chili that is used for this mixture can be whatever that provides a pleasant flavor, nevertheless, a preferred chili is selected from the group consisting of Jalapeno chili (Capsicum annuum), Bell pepper, “Yellow Lantern Chili” (Capsicum sinense), Chipotle chili (dry chili), chili of tree and mixtures thereof. Also, vegetables dehydrated such as tomato, tomato, onion, or the like according to the particular preference of the consumer can be added to the blend.

In another embodiment of the invention, a cream or sweet paste with the avocado pulp powder can be obtained of the invention, mixing the powder in 30 to 50% in weight with respect to the total weight of the cream or sweet paste, with a saturated sugar solution in a percentage from the 50 to 70% in weight with respect to the total weight of the cream or sweet paste.

In another embodiment of the invention, a marbled chocolate bar can be obtained with the avocado pulp powder of the invention, mixing from the 40 to 50% weight of the powder with respect to the total weight of the chocolate bar, and 50 to 60% weigh of chocolate of the total weight of the chocolate bar. In this case any type of chocolate can be used, but the white chocolate is preferred.

In another one of the modalities of the invention, a product of sweet confectionery, for example a caramel with the avocado pulp powder of the invention can be obtained, mixing the powder in a percentage from the 20 to 30% in weight with respect to the total weight of the candy or caramel, and a saturated sugar solution in a percentage from the 70 to 80% in weight with respect to the total weight of the candy or massive caramel.

In another embodiment of the invention, an alimentary spicy hot composition, type spicy sauce, can be obtained with the same features of conservation that of the avocado pulp powder of the invention. The sauce having the following composition: powder of the invention in a percentage in weight from the 96 to 98%, dehydrated Bell pepper in a percentage from the 2 to 4% in weight and dehydrated green tomato in a percentage from the 2 to 4% in weight, where the percentage are with respect to the total weight of the composition type sharp sauce. These ingredients provide the characteristic flavor of the spicy hot product of the avocado powder, as it can be obvious to a skilled in the art, it can be obtained mixtures type guacamole, for example.

Due to the features of the powder of the invention, this one can be compacted to generate products for direct consumption or intermediate products that later can form part of other compositions by means of their dissolution in liquids or solid or semisolids disintegration. In this way, the powders can be compacted by means of pressure through apparatuses for manufacturing tablets, graduating the compression force in such a way that the tablets can be formed. For example, the powder can be put under pressures from 900 to 50 MPa during a time of 1 to 30 minutes at room temperature, depending on the type of desired compacted product, either of fast or prolonged disintegration. In order to produce tables at industrial quantities it is preferred to use the direct or indirect compaction, although the indirect compaction is preferred. The compacted products obtained do not lose their form during the storage, allow significantly to reduce the volume of the powder and allow to conserve the sensorial properties of the dehydrated avocado pulp.

The compaction of pulp powders of avocado of the invention allows increasing its stability in the storage, because the compaction does not allow the appearance of undesirable ethereous substances that affect the amount and integrity of the components of the pulp of the fruit. In this way, the compacted products obtained according to the present invention can be conserved at room temperature at least for 1 year, which guarantees its great quality and the elimination of freezing for the transportation of the products. Consequently, the compacted products of the invention allow to keep the sensorial features of the fresh fruit in a stable and lasting way, increasing the availability for their consumption. As for the powder of the invention, the compacted products have a maximum of humidity from 2 to 7% w/w and a water activity from 0.2 to 0.59.

Due to the compaction property of the avocado pulp powders of the invention, it is possible to design compactable alimentary formulations including it, being possible to add other compactable ingredients to the formulation which provide a particular aspect or property, for example flavor, consistency or hardness. In this way, the addition of elements such as glucose and/or starch increase or reduce the consistency and viscosity of the formulation to be compacted, whereas the addition of additional flavorants, as for example chili in powder form, provides the avocado powder with additional flavors. For obtaining the above mentioned compactable formulations, the avocado powder of the invention can be added in a percentage from the 40 to 50% w/w, the glucose in a percentage from the 40 to 50% w/w, the starch in a percentage from the 5 to 10% w/w and the additional flavorants in a percentage from the 1 to 2%. In the case of the addition of chili or spices to the compactable formulation, it can be added “Piquin” chili (ground chili of tree) or jalapeno chili in powder, which allows to provide pungency to the formulation.

The following examples are given without the intention of limiting the scope of protection.

### Example 1

### Avocado Stable Pulp Powder Obtaining Method

85 kg of fresh fruits of avocado were selected, choosing those fruits with firm consistency and without damage in the rind. After separating the material selected in diverse batches equivalent to 5 kg of avocado pulp each one, these were put under washing with chlorinated water (20 ppm), draining the washing water. Then the fruits were longitudinally cut by half and the seed removed from the fruit. The fruits obtained from each one of the batches were placed in the rotatory tray of a plurality of ovens of the same specifications equipped with microwaves and air inlets and exits, according to FIG. 2. The speed of rotation of the tray is set in 2 to 8 loops per minute and providing from 10 to 80% of the power of the microwave ovens. Simultaneously air was injected to the interior of the oven at a rate of 0.2 to 0.9 m3/min through the air inlet of the oven, being the air previously warmed to a temperature of between 40 to 90° C. The dehydration for all the batches was carried out simultaneously during 40 to 90 minutes under the conditions previously mentioned, obtaining a material derived from the avocado pulp with a maximum humidity content from 8 to 12% w/w. During the dehydration process in the microwave ovens, the air injected continuously flowed within the oven and towards the exit as indicated in figures.

Finished the dehydration by microwaves, the pulp obtained and cooled to room temperature, was separated from the rind of the fruit by means of a spoon previously sanitized, disposing the rind of the fruit. Then the obtained pulp was put under dehydration by means of heat drying to a temperature of between 55 to 120° C. during a time from 0.5 to 4 hours resulting a material with maximum humidity content from 2 to 7% w/w and a water activity from 0.2 to 0.59. Once the dehydration is concluded, the obtained material was put under a continuous milling by means of a mill of blades or turbo mill until obtaining a particle size of 1 mm in at least 50% of particles. The obtained powder was sieving by means of a grain classifier, grinding again at the same conditions, the powder that has been retained in the classifier. The powder having a size of particle within the mentioned range was mixed until homogenization. Finally the obtained powder was placed in polyethylene containers or bags that were further in PET packages of 100 to 200 g capacity, some samples were taken from each one of the batches of avocado powder for its later analysis. After conducting diverse analyses in the samples of the obtained powder, the results were collected are shown in Table 1.

As it can be seen, the values of lipids ranged between 60 to 65% w/w, whereas the values of protein were in the rank from 6 to 7% w/w and those of carbohydrates between 5 to 6% p/p in average. Likewise, most of obtained powders exhibited very similar compositions and very similar energetic values. Respect to the enzymatic activity, it was not detect activity of polyphenoloxidase (PFO), whereas the proteolytic and lipase activity remained very low, within the awaited rank. On the other hand, the values of water activity remained in the interval from 0.2 to 0.5, which is congruent with the undetected microbial growth in the samples, even though the microbial growth tests were conducted in sterile means rich in nutrients.

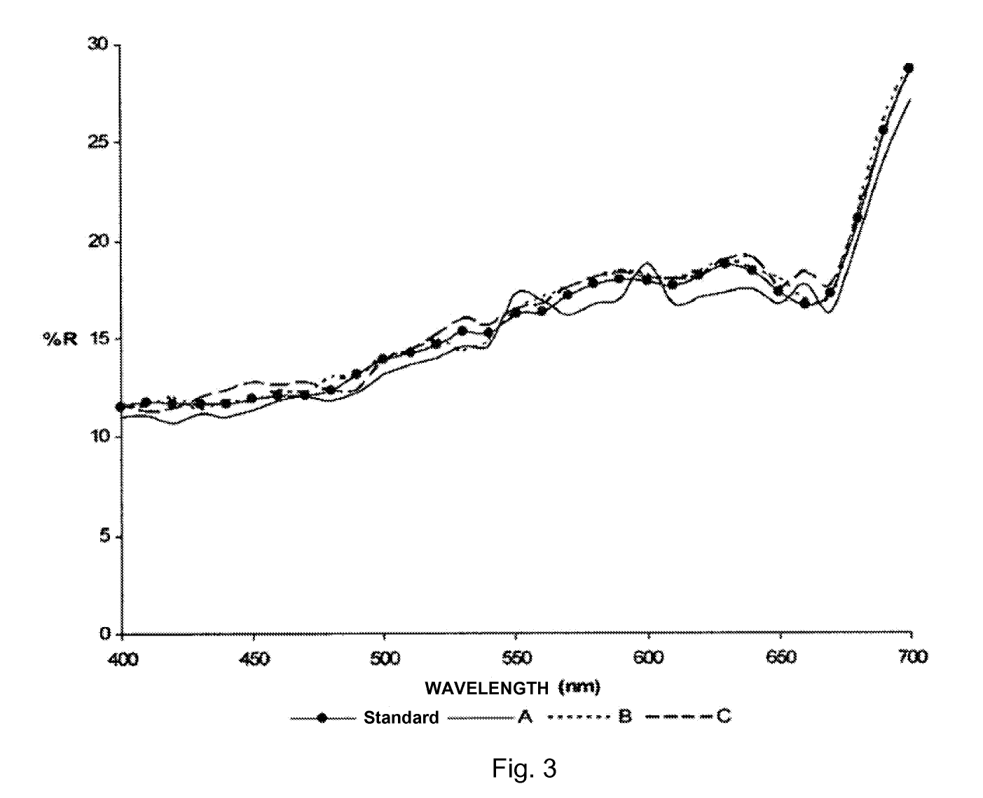

In order to determine the effect of the dehydration of the invention on the color, a color determination of the samples of the batches obtained was performed measuring the reflectance in an interval from 700 400 to nm of the material and compared with no dehydrated fresh avocado pulp as control. The control sample consisted in a spoonful of avocado pulp that was disintegrated and mixed until obtaining a paste of homogenous color. As it can be seen in the FIG. 3, the batches of powders of the invention (11, 17 and 24) did not undergo alteration in the color in comparison with the observed values of color for the fresh pulp of non-dehydrated avocado.

As it can be seen, the avocado pulp powders of the invention do not undergo alterations in their components and aspect due to the null activity of polyphenoloxidase, low enzymatic activity of lipase and protease and low water activity exhibited, which guarantees the preservation of its sensorial properties. Moreover, the addition of natural and/or synthetic conservatives is not necessary to allow the conservation of the properties of the powder.

TABLE 1
Features of the Avocado powder of the invention

| | % w/w* | | | | | | | CE* | Enzimatic activity+ | | | Microorganism | | | |
|---|---|---|---|---|---|---|---|---|---|---|---|---|---|---|---|
| Batch | Humidity | Lipids | CHO | Protein | Ash | FC | ENN | (Kcal) | PFO | Prot | Lip | Meso | Fecal | Total | WA** |
| 10 | 3.82 | 64.20 | 5.73 | 6.48 | 4.86 | 13.71 | 1.2 | 626 | 0 | 123 | 12.5 | N/D | N/D | N/D | 0.423 |
| 11 | 3.26 | 63.49 | 8.02 | 7.37 | 5.61 | 13.71 | 1.05 | 633 | 0 | 123 | 12.5 | N/D | N/D | N/D | 0.435 |
| 12 | 3.71 | 70.15 | 5.71 | 6.43 | 4.81 | 8.12 | 1.07 | 680 | 0 | 123 | 12 | N/D | N/D | N/D | 0.428 |
| 13 | 2.22 | 60.29 | 5.35 | 6.52 | 5.4 | 8.15 | 1.04 | 630 | 0 | 123 | 12.5 | N/D | N/D | N/D | 0.451 |
| 14 | 2.21 | 63.42 | 5.3 | 7.31 | 5.78 | 8.22 | 1.06 | 635 | 0 | 123 | 12 | N/D | N/D | N/D | 0.445 |
| 15 | 2.97 | 46.06 | 4.89 | 7.35 | 5.5 | 8.32 | 1.05 | 650 | 0 | 123 | 12.5 | N/D | N/D | N/D | 0.433 |
| 16 | 3.26 | 63.49 | 8.02 | 7.34 | 5.61 | 8.34 | 1.05 | 633 | 0 | 123 | 12.5 | N/D | N/D | N/D | 0.472 |
| 17 | 3.37 | 64.25 | 5.63 | 6.47 | 4.82 | 10.35 | 1.05 | 634 | 0 | 123 | 12.5 | N/D | N/D | N/D | 0.426 |
| 18 | 2.24 | 63.21 | 4.24 | 7.35 | 4.78 | 8.67 | 1.08 | 657 | 0 | 123 | 12.5 | N/D | N/D | N/D | 0.457 |
| 19 | 3.36 | 64.25 | 5.26 | 6.55 | 4.68 | 8.21 | 1.04 | 658 | 0 | 123 | 12.5 | N/D | N/D | N/D | 0.438 |
| 20 | 3.54 | 64.36 | 5.36 | 7.34 | 4.77 | 8.36 | 1.02 | 665 | 0 | 123 | 12.5 | N/D | N/D | N/D | 0.457 |
| 21 | 3.27 | 63.24 | 5.68 | 6.58 | 5.03 | 8.54 | 1.06 | 646 | 0 | 123 | 12.5 | N/D | N/D | N/D | 0.439 |
| 22 | 2.65 | 64.57 | 5.45 | 6.57 | 5.21 | 8.65 | 1.2 | 649 | 0 | 123 | 12.5 | N/D | N/D | N/D | 0.452 |
| 23 | 3.21 | 63.32 | 5.39 | 7.31 | 5.33 | 8.58 | 1.04 | 680 | 0 | 123 | 12.5 | N/D | N/D | N/D | 0.415 |
| 24 | 3.33 | 63.24 | 5.35 | 7.33 | 4.87 | 8.51 | 1.05 | 675 | 0 | 123 | 12.5 | N/D | N/D | N/D | 0.501 |
| 25 | 3.58 | 63.35 | 5.47 | 7.35 | 4.83 | 8.43 | 1.06 | 688 | 0 | 123 | 12.5 | N/D | N/D | N/D | 0.472 |

*Per each 100 g of powder.
CHO Carbon hydrates
FN Raw fiber
ENN No -nitrogenated extract
EN Energy content
Prot Protease
Lip Lipase
N/D Non detected
WA Water Activity
+PFO Polyphenol oxidase (unity of polyphenol oxidase)
Protease (mg Tirosine delivered/h per gram)
Lipase (mM/g per hour)
**Mesured using Decagon-Aqualab ™ at 25° C.

On the other hand, representative samples of the batches of the powder of the invention were analyzed regarding the size of particle by means of the use of sieves of diverse mesh sizes and analyzing the percentage of retention of particles in each one of them. As it can be seen from Table 2, around 88% of the particles of the powder conserved a size of particle from 710 to 1,400 μm, showing small percentage of particles with greater or smaller sizes.

TABLE 2
PARTICLE SIZE OF THE AVOCADO POWDER

| | | % retained |
|---|---|---|
| Mesh | μm | particles |
| 10 | 2000 | 0.25 |
| 12 | 1700 | 6.40 |
| 14 | 1400 | 21.69 |
| 18 | 1000 | 45.57 |
| 25 | 710 | 21.07 |
| 35 | 500 | 4.58 |
| 50 | 300 | 0.42 |

### Example 2

### Shelf Stability of the Avocado Powder

The powder of the invention was put under storage by the course of 1 year at room temperature, safe from the solar light before to determine its sensorial properties. The powder exhibited typical scent, color and flavor to the avocado pulp, and it was not observed bind of particles nor contamination of any type.

### Example 3

### Compacted Product Obtaining Using the Powder of the Invention

The powders obtained in example 1, were mixed with the components that are observed in table 3 with the purpose of obtaining tablets.

TABLE 3
Compactable Compositions containing avocado powder

| | Formulation | Formulation |
|---|---|---|
| Component | 1 | 2 |
| Avocado powder | 40 | 50 |
| Glucose | 50 | 40 |
| Starch | 10 | 10 |

Expressed in % w/w

For obtaining formulation No. 1, the powder of the invention was sifted previously by means of mesh 14 to 25 and mixed then with glucose and starch during 3 minutes, in such proportions to obtain tablets of between 200 and 300 mg of weight. Then the obtained mixture was put under compression of between 5 to 7 MPa in a machine.

With respect to formulation 2, the powder of the invention was sifted previously by means of mesh 14 to 25 whereas the glucose and the starch were sifted by mesh 25. Then the sifted powders were mixed during 3 minutes in the amounts shown in Table 3 to obtain tablets from 600 to 700 mg of weight, being the mixture put under a compression from 5 to 7 MPa by means of a machine. The resulting tablets exhibited a hardness of 10 KP and a humidity content of 7.22% in average. Then, the formulation was put under coating. The obtained tablets were placed in acrylic packages or bottles made of PET or glass for their conservation and storage.

In addition to the compositions of tablets of Table 3, a 2% w/w of Piquin or Jalapeno chili was added, and compacted under the mentioned conditions.

In all the cases, the tablets exhibited the color and flavor characteristic of the fresh avocado pulp, whereas those that contained chili, additionally exhibited pungency.

### Example 4

### Obtaining of Capsules Using the Powder of the Invention

1 g of each one of the compositions mentioned in example 3, were introduced in gel capsules. The capsules exhibited good dissolution in the presence of water as well as the formulation encapsulated.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

1. A method for obtaining a stable avocado pulp powder dehydrated in a microwave oven, comprising:
a) providing a plurality of whole fruits of avocado;
b) washing the whole fruits of avocado;
c) cutting the whole fruits of avocado in at least two portions;
d) retiring the seed of the fruits;
e) conducting a first dehydration of the portions of the fruits of avocado in at least a microwave oven that has a air supply, until a maximum humidity content of the pulp between 8 to 12% w/w;
f) conducting a second dehydration of the portions of the fruits obtained the first dehydration until a maximum humidity content 2 to 7% p/p; and
e) grinding portions of the fruits remaining after the second dehydration to a particle size of 0.5 to 2.5 mm.

2. The method claim 1, wherein the first dehydration is conducted at a speed of rotation tray within the oven of 2 to 8 returns per minute and power between 10 to 80% of the total power of the microwave oven, and the air supply has a temperature of between 40°-90° C. and a flow of between 0.2-0.9 m³/min.

3. The method for claim 1, further comprising removing the rind of the fruits.

4. The method claim 1, wherein the second dehydration is selected from dehydration by heat dry or by hot air at a temperature of between 60-120° C., and a time of between 3-6 hours.

5. The method claim 1, further comprising compacting the powder applying a pressure of between 90-900 MPa 1-30 minutes.

6. A stable avocado pulp powder, obtainable by the method of claim 1, comprising:
a) a water activity from 0.2 to 0.59;
b) a humidity of between 2-7% w/w with respect to the total weight of the powder,
c) lipids in a percentage from 60% to 70% weight with respect to the total weight of the powder,
d) proteins in a percentage from 6% to 7% weight with respect to the total weight of the powder; and
e) carbohydrates in a percentage from 5% to 6% weight with respect to the total weight of the powder.

7. The powder of claim 6, wherein the powder has a particle size of 0.5 to 2.5 mm.

8. The powder of claim 6, wherein the powder is in compacted form.

9. An alimentary composition including the stable avocado pulp powder in accordance with claim 6.

10. The composition of claim 9, wherein the stable avocado pulp powder is in a percentage of between 10 to 20% weight with respect to the total weight of the composition.

11. The composition of claim 9, wherein the composition is selected from group consisting of confectionery products, desserts, pies, mousses, frozen yogurts, syrups drinks.

12. The composition of claim 9, wherein the powder is embodied as tablets of stable avocado pulp powder.

13. An alimentary stable pulp dust formulation of avocado, comprising:
a) stable avocado pulp powder of claim 1 in a percentage of between 40 to 50% weight with respect to the total weight of the formulation;
b) glucose in a percentage from 40 to 50% weight with respect to the total weight of the formulation; and
c) starch in a percentage from 5 to 10% weight with respect to the total weight of the formulation.

14. The formulation of claim 13, further comprising 2% w/w of a spicy hot selected from ground piquin and jalapeno chili.

15. Alimentary product based on stable avocado pulp powder comprising:
a) the stable avocado pulp powder of claim 1 in a percentage from the 90 to 95% weight with respect to the total weight of the product, and
b) chili in a percentage from 5 to 10% weight with respect to the total weight of the product.

16. The product of claim 15 wherein the chili is selected from group consisting of Jalapeno chili, Bell pepper, “Yellow Lantern Chili, Chipotle chili, chili of tree and mixtures thereof.

17. An alimentary product with the stable avocado pulp powder, comprising:
a) the stable avocado pulp powder of claim 1 in a percentage from 30 to 50% weight with respect to the total weight of the product, and
b) a saturated sugar solution in a percentage from 50 to 70% weight with respect to the total weight of the product.

18. An apparatus for dehydrating an avocado pulp using microwaves, comprising:
at least a microwave oven that has a hot air inlet and exit;
means to warm up the air flow placed in an air intake that warms the air to a given temperature, and;
means to control the air flow of air supplied to the interior of the oven placed in the air intake.

19. The apparatus of claim 18, wherein the means to warm up the air flow consist of an electric resistance from 100 to 300 watts.

20. The apparatus of claim 18, wherein the hot air inlet and exit are connected one independently of the other to a stainless steel duct.

21. The apparatus of claim 18, further including a humidity controller placed in the exit of hot air to sense the humidity content of the air flow that leaves the microwave oven.

22.-34. (canceled)
